(19) United States
(12) Patent Application Publication
(10) Pub. No.: US 2019/0088140 A1
(43) Pub. Date: Mar. 21, 2019

(54) System for autonomously marking road worker or construction activity in vehicle navigation systems

(71) Applicants: Ross David Sheckler, Cato, NY (US); Adam Parker Kovar, Geneva, NY (US)

(72) Inventors: Ross David Sheckler, Cato, NY (US); Adam Parker Kovar, Geneva, NY (US)

(21) Appl. No.: 15/710,040

(22) Filed: Sep. 20, 2017

(51) Int. Cl. G08G 1/00; G01C 21/28

(52) U.S. Cl. CPC G08G 1/20; G01C 21/28

(57) ABSTRACT

A sensing and communications system that can be embedded in selected road construction equipment that enables the presence, location, and purpose of the equipment to be inserted in vehicle navigation systems through existing networks with no specialized skills.

### CROSS REFERENCE TO RELATED APPLICATION

This application claims the benefit of U.S. Provisional Application No. 62/399,056 filed on Sep. 23, 2016, entitled “System for autonomously marking road worker or construction activity in vehicle navigation systems”.

### BACKGROUND OF THE INVENTION

The present invention relates to the generation of data records for traffic information systems. The invention serves the purpose of automating the transmission of worker location and activity allowing traffic information systems to represent the activity of road construction workers and traffic control equipment.

The operation of the modern highway system and its navigation requires precise information on the presence traffic control equipment and the activities of construction workers. Current highway operations in many of the United States require only the roughest reports on construction activities as they relate to traffic and mobility. These processes generally require the workers to schedule work times in advance and telephone traffic centers with actual activities or changes to the schedule. The realities of weather, and logistics make precise scheduling very difficult so the schedules that are filed with traffic management centers tend to cover dates and times that are in excess of the time that is needed to complete the work. In the best cases worker will place a phone call to the traffic management when the work is actually going to commence. Such phone calls are frequently forgotten or ignored and are not used to update changes in work zone status as work progresses. As a result, the transportation agency's traffic management centers generally have little timely data on the activities within work zones.

The invention is an electronic controller with geo-location capability, serial inputs, and radio, or modem, designed to be embedded in or added to existing construction equipment such as arrow-panels, flashing-lights, crash-trucks, or flagger stop paddles.

### SUMMARY OF THE INVENTION

The invention combines GPS technology, magnetic, gravitational, and motion sensors, as well as serial inputs to establish the location and orientation of the device. When added to common construction equipment such as signs, lights, barricades, and trucks the invention automatically determines the location, orientation, and status of the equipment. This information is indirectly conveyed to the navigation systems of vehicles in the area using existing communication networks and data centers.

Current techniques for establishing the presence of construction equipment is through a series of construction project drawings, known as a traffic control plan, which are established months prior to the execution of a project. Any transfer of the orientation of a road construction site to a vehicle's navigation system must be done by manually transcribing the information on the drawings into a digital map. When traffic control patterns change as construction progresses the execution of that change is noted by crew members calling traffic centers and describing the new traffic control set-up.

Conventional views of future vehicle information systems are centered around creating new construction equipment which includes specialized dedicated short-range communications systems and establishing a new high-powered network that allows the construction equipment to send identifying information to vehicles that are equipped to receive this new signal.

The invention is designed to forgo the need to develop new construction equipment or new communication channels to provide motor vehicles with up-to-the-minute information on the position, orientation, and status of construction equipment. The invention combines a simple, low-powered cellular communications device acting as ‘worker’ combined with a centralized data server, acting as a ‘host’, which collects and interprets messages from multiple ‘workers’. The ‘host’ data server both interprets the messages from the ‘workers’ and serves as a clearing house distributing data on the location and function of construction equipment to the data centers of vehicle navigation systems.

The structure of the road construction industry requires that the equipment be owned by one of a series of contractors and the equipment moves from job to job and region to region. The resulting reality is that the equipment on any construction project cannot be expected to be known by the local transportation agency or transportation data centers. In the case of this invention, the ‘worker’ device and the ‘host’ system do not need prior knowledge of the construction project, the ownership of the ‘worker’, or how to address the ‘worker’. The ‘worker’ initiates the communications protocols, identifies itself and its location to the ‘host’ and the ‘host’ includes it in its existing posting of data to the transportation data centers.

The data from the ‘worker’ on the specific orientation of the device with respect to the construction equipment and with respect to the local geography as well as serial inputs allow the data server to build a specific map of the road construction. An open format posting available to the navigation data centers allows the road construction that is regionally relevant to vehicles to be transferred to the specific navigation devices.

The lane closure traffic control plan shown in FIG. 1 is a simple example of how the device can be applied to a number of pieces of equipment. In this case the following equipment has been modified.

Lights (FIG. 1, item B) on the ‘workers present’ sign have the device included so as the lights are activated the location and status of the sign is transmitted via cellular communications to the data center and passed on to the navigation data aggregators so that vehicles traveling in the region can know that the work zone is now ‘active’.

The lighted arrow panel (FIG. 1, item C) has been modified with the device so that when the sign is activated to indicate a shift to the left the data center receives the location and status information. The data is then passed to the navigation data aggregators so that vehicles in the region can know that it is necessary to merge left at that location.

The crash cushion (FIG. 1, item E) at the end of the barrier wall has been modified with the device in order to monitor collisions. The data center is updated with the location and status of the crash cushion. The data is passed to the navigation data aggregators so that vehicles in the region can be aware of the hard obstacle.

### BRIEF DESCRIPTION OF THE DRAWINGS

The characteristic features of this invention will be particularly pointed out in the summary of the invention and the claims, the invention itself and manner in which it may be made and used may be better understood after a review of the accompanying drawings.

FIG. 1 shows a highway construction traffic control plan in which the invention is applied to a variety of types of equipment to mark the status and location of traffic control systems.

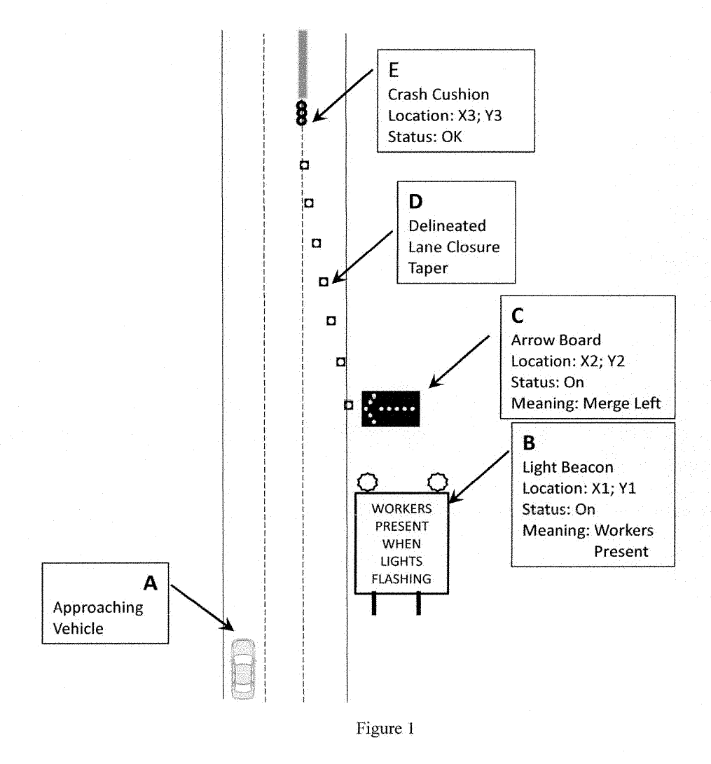

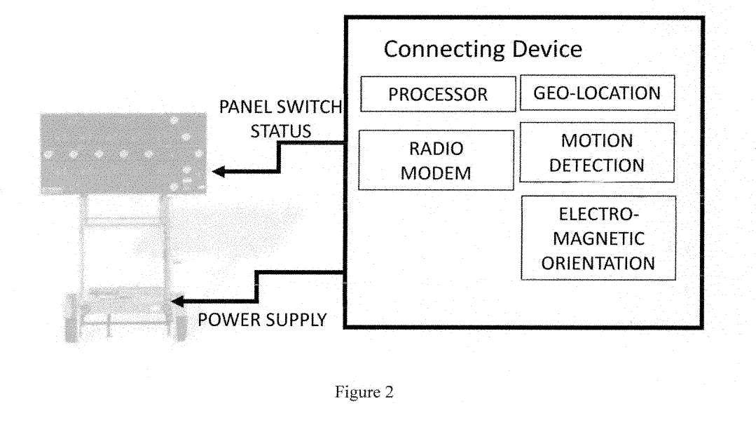

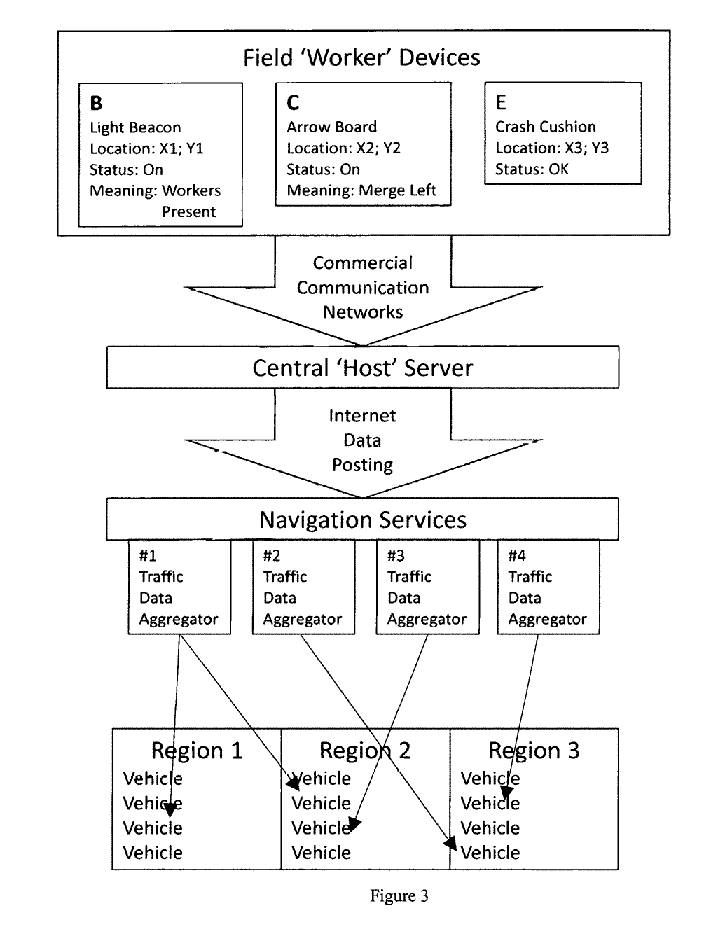

Lights (FIG. 1, item B) on the ‘workers present’ sign have the device included so as the lights are activated the location and status of the sign is transmitted via cellular communications to the data center and passed on to the navigation data aggregators so that vehicles (FIG. 1, item A) traveling in the region can know that the work zone is now ‘active’.

The lighted arrow panel (FIG. 1, item C) has been modified with the device so that when the sign is activated to indicate a shift to the left the data center receives the location and status information. The data is then passed to the navigation data aggregators so that vehicles in the region can know that it is necessary to merge left at that location.

The traffic cones that delineate the lane closure taper (FIG. 1, item D) have been modified with the device to provide precise location of the boundary of the work area.

The crash cushion (FIG. 1, item E) at the end of the barrier wall has been modified with the device in order to monitor collisions. The data center is updated with the location and status of the crash cushion. The data is passed to the navigation data aggregators so that vehicles in the region can be aware of the hard obstacle.

FIG. 2 shows a top-level diagram of how the invention works with a piece of construction traffic control equipment to become the status and location monitoring system for a larger traffic monitoring and vehicle navigation network.

FIG. 3 shows a system flow diagram in which the invention works with information systems to relay construction traffic control information to the navigation systems of automobiles.

1. An autonomous communications device used to modify construction equipment to provide for centralized identification, location, and orientation of the equipment.

2. A single device which can be used for multiple types of equipment.

3. A device which can modify and improve existing equipment.

4. A low-power cellular communications device for construction equipment programmed to automatically, and without prior coordination, establish contact with a data center upon activation.

5. A communications device with sensors that allow it to automatically establish location, heading and orientation.

6. A data system for the management of multiple devices that potentially lie dormant for long periods of time and introduce themselves to the system with no notice.

7. A data system that interprets the worker device information as a highway construction traffic control plan.
